(19) United States
(12) Patent Application Publication
(10) Pub. No.: US 2001/0051903 A1
(43) Pub. Date: Dec. 13, 2001

(54) Personal digital shopping trolley

(75) Inventors: Uwe Hansmann, Altdorf (DE); Lothar Merk, Schoenbuch (DE); Thomas Stober, Boeblingen (DE)

Correspondence Address: William A. Kinnaman, Jr., IBM Corporation, Intellectual Property Law Department, 2455 South Road M/S P386, Poughkeepsie, NY, 12601, US

(73) Assignee: INTERNATIONAL BUSINESS MACHINES CORPORATION, Armonk, NY

(21) Appl. No.: 09/897,869

(22) Filed: Jul. 2, 2001

(30) Foreign Application Priority Data
Apr. 7, 2000 (DE) 00114340.3

(51) Int. Cl. G06F 17/60; G06F 7/00; G06F 17/00

(52) U.S. Cl. 705/26; 707/104.1

(57) ABSTRACT

The present invention relates to computer-aided shopping systems. With the help of a customer-associated mobile computing device having an adequate interface to a product data source the customer is enabled to easily gather any relevant product information including technical information about the product or variations of it, he can store the information without any purchase decision necessary to be taken in the shop and he is enabled to retrieve the information including technical information for example at home by exporting the product information via a standard interface onto his personal desktop PC for further analysis or revision. Thus, the advantages of real shopping are combined with the advantages of any kind of virtual shopping.

### BACKGROUND OF THE INVENTION

1. Field of the Invention

The present invention relates to computer-aided shopping systems.

2. Description of the Related Art

Shopping is an engine of the economy.

The most common way to shop is to stroll through one or more shops in which a person looks for the goods he or she is interested in. Most products for everyday consumption are bought in this way. The advantage of this kind of real shopping is that the customer who is interested in buying a product can see the product in reality before he decides to buy it. The problem with real shopping, however, is that it costs much time for the customer when he wants to compare the products of several vendors before any purchase decision. Then he must enter a plurality of shops, search the products, gather all relevant product information, compare the information, and finally go back to that particular shop which made the best offer for the specific needs of the customer.

In order to avoid a large time consumption a catalogue-based shopping is also practiced broadly. In a catalogue all relevant products offered by a specific vendor are visualized in paper form including a short description of their technical features and including price information. The disadvantage is that the customer can neither see nor touch the product before he decides to purchase or at least order it, respectively.

A third way for shopping is the so-called Internet shopping, which is a kind of electronic form of catalogue shopping. In most cases of Internet shopping the catalogue of products is presented and accessible on the Web site of the vendor. The advantage is that product information is very quickly available for the customer without any need to order a catalogue first, and for the vendor the cost is saved necessary to produce and distribute colored print media as it is a product catalogue.

These three basic ways of shopping are, however, not disjoint. Instead, with increasing acceptance of mobile computing devices, as for example a handheld, a Palm Pilot or an organizer, or other personal digital assistant (PDA), some computer-aided shopping systems have emerged which try to combine the advantages offered by some of the above-mentioned ways of shopping.

An example is a software/hardware combination in form of a Palm Pilot which has installed some piece of software, called easy-order-safe-way. By aid of the Palm Pilot customers are enabled to select their desired products at home from a list, to issue an order comprising the selected products to a service provider who collects the products from one or more shops and puts them into one packet which the customer can pick up at the service provider, or in a particular shop, respectively. Such an integrated solution PDA, however, implements only proprietary applications for use in a single store or a small plurality of them.

An alternative provided by the prior art is to use the Palm Pilot for scanning the products to be purchased in a shop and putting them into a shopping cart. This helps to avoid queues in front of the cashier because the products need not be put one by one onto the conveyor belt and scanned in one by one.

The latter prior art technology, however, fails to combine all the advantages provided by the above-mentioned three systems because the customer is not enabled to see or touch the products before purchase in the first alternative mentioned above or, in the second alternative, because he is not enabled to compare the offers with offers of one or more competitors of the vendor.

Thus, there is no approach which really integrates virtual and real shopping sites. If, for example, the consumer wants to compare offers from different vendors or just browse the store and submit the order later, the only way to do this is to take a piece of paper and write the information down. He then can call the shop from at home to order specific items.

It is thus an object of the present invention to provide a computer-aided shopping system which is more flexible and more useful for the customer.

### SUMMARY OF THE INVENTION

This object of the invention is achieved by the features stated in the appended independent claims. Further advantageous arrangements and embodiments of the invention are set forth in the respective subclaims.

According to its basic aspect the present invention provides for the customer to import relevant product information, such as base price, fixed product properties like color, technical information for the product, etc., into a mobile computing device such as a PDA or even a smaller device just having an input interface for reading some product information, a memory for storing the product information and an output interface for further processing the product information and, optionally, a display for displaying some control information useful for the customer during his walk through the shop and gathering product information.

Thus, it is possible for the customer to walk through the shop having a mobile computing device in his hand and to scan all relevant product information he needs simply by entering the product ID via any kind of adequate interface between its mobile device and the shop's enterprise resources planning system, abbreviated herein as ERP system. This is to be basically understood herein as any kind of backend application, integrated solution, database application, etc., which is used by the shop for managing any services in context with their products, i.e., ordering from manufacturer, stock management, store supervision, price management, payment management, etc. Thus, by this ERP linkage, a large variety of relevant product information is quickly accessible for the customer, far more than representable on a prior art pricing label, and can be easily updated by the shop management, e.g., customer-related discount, or earliest delivery date.

The customer only has to go to a so-called product contact point and/or service point to exchange data between his PDST and the shop's backend systems and use some kind of protocol for data exchange or data requesting from the backend system, advantageously a standardized protocol as is referred to later.

Dependent on the type of offered goods the required infrastructure of product contact points and service points can be scaled. Applying barcodes in “bricks-and-mortar” stores is definitely cheaper, but offers less possibilities than for example infrared ports. But the lack in functionality of barcodes can be compensated for by a reasonable infrastructure of service points distributed in the store.

After importing the product information the customer is enabled to retrieve it at a later point in time independent of the shop's electronic shopping system.

In other words, with the help of a customer-associated mobile computing device having an adequate interface to a product data source the customer is enabled to easily gather any relevant product information including technical information about the product or variations of it, he can store the information without any purchase decision necessary to be taken in the shop and he is enabled to retrieve the information including technical information for example at home by exporting the product information via a standard interface onto his desktop personal computer (PC) for further analysis or revision. Thus, the advantages of real shopping are combined with the advantages of any kind of virtual shopping because the customer himself selects any product data he is actually interested in and he can touch the products before purchase.

Further, via the same interface product data and sales condition data retrieved from the Internet Web site of one or more shops can be imported into the mobile device. This is helpful because the user has an immediate access to the additional data when he later enters into a further competitor's shop. Knowing the price, the sales conditions and maybe technical features of the products from one or more competitors the user is enabled to make a well-considered purchase decision, even immediately in the shop, if required.

According to a further aspect of the present invention the basic approach can include advantageously the import of any kind of further sales-related additional information, of delivery-related information like delivery date, delivery conditions, delivery price supplements, creating an order for the product and sending the order to the associated vendor, and even to initiate payment for the product. Thus, the advantages of online shopping can easily appended to the basic approach described above.

According to a further advantageous aspect of the present invention product information can be gathered at a plurality of different shops associated with different vendors. After the customer has exported the gathered information from the device onto his PC at home via any suitable interface he can evaluate the different offers easily by running an evaluation tool of the present invention, which can simply be a viewer which displays all relevant text and image information in a way easy to understand for the customer.

Further, a data import facility is provided advantageously from the Internet onto the device. Thus, the user can import the product information from a competitor and access it easily at the vendor in his shop for compare purposes.

Advantageously a programming concept like XML can be used for implementing the interface which receives the product information from the shop's proprietary ERP system and represents it in the mobile device associated with the customer.

Thus, in the shop a counterpart interface is provided which implements an export of the product information which advantageously is supported by a standardized interface.

Thus, by aid of the present invention the following scenario can be realized: In online shops as well as in a conventional store the consumer can load the product information, including price and description, onto a virtual shopping basket of his handheld computing device, his so-called “personal digital shopping trolley”, further abbreviated herein as PDST. The customer can easily compare different offers from different vendors where and whenever he might want to. After making a decision which products he wants to buy, he can create the order and send it to the merchant. Additional services a personal digital shopping trolley can offer are secure payment and setting up delivery arrangement.

The present invention brings along, however, further secondary economical effects. It allows one to apply the concept of so-called service portals to virtual and non-virtual shopping. Thus, an access interface can be used by different content providers to expose their offering to customers. From the merchant's point of view, it allows one to split up and separate product information, sales, delivery and payment management into independent pieces which can be provided by different parties. From the customer's point of view it integrates the entire shopping process seamlessly, including Internet shopping and traditional store-based shopping.

From a certain point of view the PDST is comparable to a regular shopping trolley. The consumer can load goods into it, he can check and compare the current contents and unload again. Finally when he is set, he can go to a check-out station and place orders, arrange deliveries and pay for products.

It is a remarkable advantage that the customer is not limited to the offers of one store, but can stroll through multiple stores including even Internet shopping sites. Extensive downloadable product descriptions replace the traditional small label attached to products in today's stores. Up-to-date information on, e.g., availability and delivery date save queuing for a clerk. Instead of loading heavy goods into the trolley the customer just moves a virtual link to his virtual shopping basket. Instead of being limited to the available often crowded check-out station for paying, he can access his preferred payment service provider through the Internet later on when he is at home again. In addition he could also track the status of his orders or take advantage of special rates and payment conditions stored within a personal customer e-vault.

The different merchants with their different price and service offerings are integrated seamiessly into the PDST and the underlying inventive concepts. Although the entire shopping activity appears to the customer as one integrated process, all single steps like product offering, consulting, pricing, payment and delivery can be performed by different entities, i.e., providers, if desired. Single steps of the shopping process can be outsourced easily without affecting the customer. This allows upcoming service portals to be involved. For example a delivery or payment service could be advantageously applied within this invention.

The advantages of the proposed invention can be summarized by the following items:

Customer Convenience

The present invention brings the convenience of online-shopping to “bricks-and-mortar” stores. Product information, selection, order, delivery, and payment services are offered through one defined standard interface at any time and almost any place, independently of the entity who offers the service, allowing the customer to compare multiple competitive offers.

Customer Mobility

The PDST integrates shopping in the real and in the virtual world and it seamlessly integrates shopping-related services for the customer into a mobile shopping scenario. All goods chosen from an enabled virtual or non-virtual shopping site are stored on the customer's mobile pervasive device, until the customer decides to buy or reject the selection. He can carry around and manage all collected offers at any time from any virtual and non-virtual shopping site which allows him to rethink the expense at home and to order whenever he likes to.

Customer Flexibility

Being able to arrange delivery, configure orders or choose the preferred payment method increases the customer's flexibility. He can combine the advantages of support by trained staff, online store and Internet information as he likes to.

Merchant Flexibility

By allowing online connections between the customer's PDST and his ERP system, the merchant can provide flexible up-to-date information specific to individual customers and specific to individual discount offers. Enabling the customer to configure his orders saves costs and time and reduces the required staff.

Merchant Added Value

Individual customer services combined with loyalty programs and enhanced convenience represent an important added value for differentiation.

Merchant Outsourcing Opportunities and Merchant Cooperation Opportunities

The possibility to separate different parts of the entire shopping process without impact to the customer allows strategic outsourcing as well as new cooperation alternatives between different merchants and other service providers such as financial institutions.

Merchant Internet Offering

The possibility of integrating Internet and store-based shopping into a worldwide shopping network offers new opportunities for growth and impacts current Internet shopping sites.

Scalable Investments

By using common pervasive devices like mobile phones or PDAs for installing the PDST application, the merchant can delegate the significant investment of the needed devices to the customer. Using his own familiar device with a standardized PDST application the customer does not have to install and learn a new shopping application at each shop, nor he has to enter his personal information in a wide variety of systems again and again.

### BRIEF DESCRIPTION OF THE DRAWINGS

The present invention is illustrated by way of example and is not limited by the shape of the figures of the accompanying drawings in which:

FIG. 1 is a schematic structural representation showing the most essential components contributing to the shopping communication method of the present invention according to a preferred embodiment thereof;

FIGS. 2A-2C are schematic functional representations of the embodiment revealing control flow aspects of a exemplarily chosen instantiation thereof;

FIG. 3 is a schematic functional representation giving an overview of FIG. 2;

FIG. 4 is a schematic functional representation of the embodiment focusing on its large flexibility and variability.

### DESCRIPTION OF THE PREFERRED EMBODIMENT

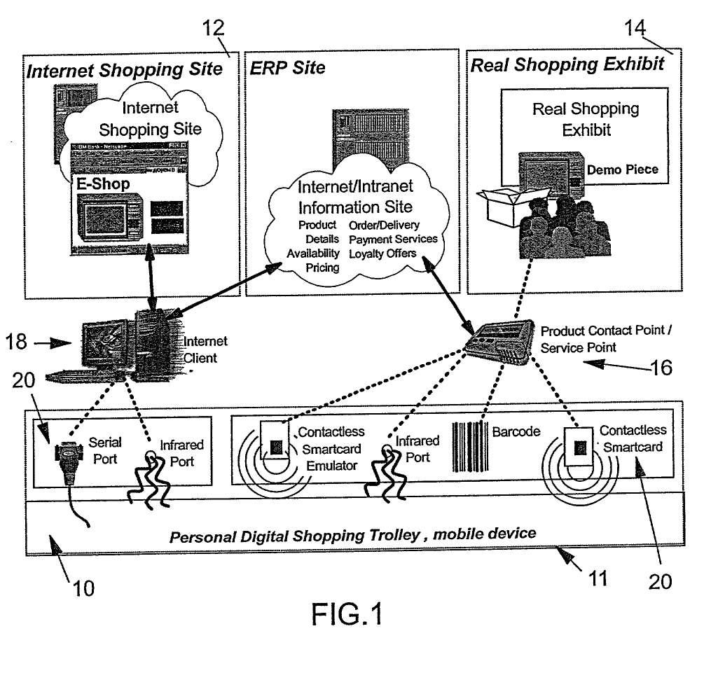

With general reference to the figures and with special reference now to FIG. 1 the personal digital shopping trolley 10 (DST) of the present invention is a piece of software that the consumer uses which is implemented on a pervasive device 11, depicted schematically as a Palm Pilot, mobile phone, PAD, etc.

While the consumer is browsing through a virtual shop 12 or is walking through a real-life store 14, he can get information assigned to a product in which he is interested and interact with the respective merchant for arranging order, delivery and price.

A real-life store 14 has equipped its product exhibition with a plurality of product contact points 16, which offer DST devices 11 the required access to product and merchant data. In a virtual store this data is exchanged through, e.g., the Internet to the customer's Internet client computer, usually a personal computer (PC) 18, which acts as a product contact point as well. In both cases the product contact point can be contacted by the DST device using common physical interfaces 20 such as infrared, contacts smart cards, braced or serial ports, etc. For the data exchange between product contact points 16 and DST device 11, a logical DST interface, further referred to herein and abbreviated as Past, is defined. The Past offers functions for getting product, vendor and personal customer information. It allows one to access the merchant's REP system in order to retrieve online information such as price or availability. Additionally, the consumer can access a personal customer e-vault on the merchant system. This e-vault can store information about loyalty points, discounts, vouchers or special rates on the prices.

The PDSTi further advantageously includes functions for obtaining descriptive information about product and vendor, for loading the product into the virtual shopping basket, i.e., some storage means of the PDST, for obtaining the price, arranging the delivery, for confirming the order and for performing a secure payment. Advantageously the interface uses XML programming techniques in a standardized way.

Due to the different capabilities of the different physical interfaces 20 depicted in FIG. 1, different subsets of the PDSTi functionality will be supported. For example a barcode allows only a single-direction communication, e.g., preventing the customer from sending an order.

Contactless smart cards attached to the product do not allow online access to the shop's backend systems which might be needed for delivery arrangements. Choosing a cheaper physical interface technology such as barcode is preferred in order to reduce the merchant's investment.

Selecting, however, a very sophisticated technology like an infrared port is definitely appropriate for very expensive products like, e.g., furniture or cars, where up-to-date information about the product is an essential service for the customer.

Beside the product contact points located at the exposed product itself, additional multifunctional service points can be located in the store, in dedicated service centers or on the Internet, as well. Service points 16 can be logically regarded as product-independent product contact points. They offer the full functionality of the PDST interface 20, including the online access to the merchant system, which is needed for ordering, payment and delivery. Service points 16 can be used any time when working through the shopping basket on the PDST, e.g., after a long shopping day at the desktop PC 18 at home. If the installed product contact points use only simple physical interfaces such as infrared, the service points are the only possibility for obtaining online access to the merchant systems.

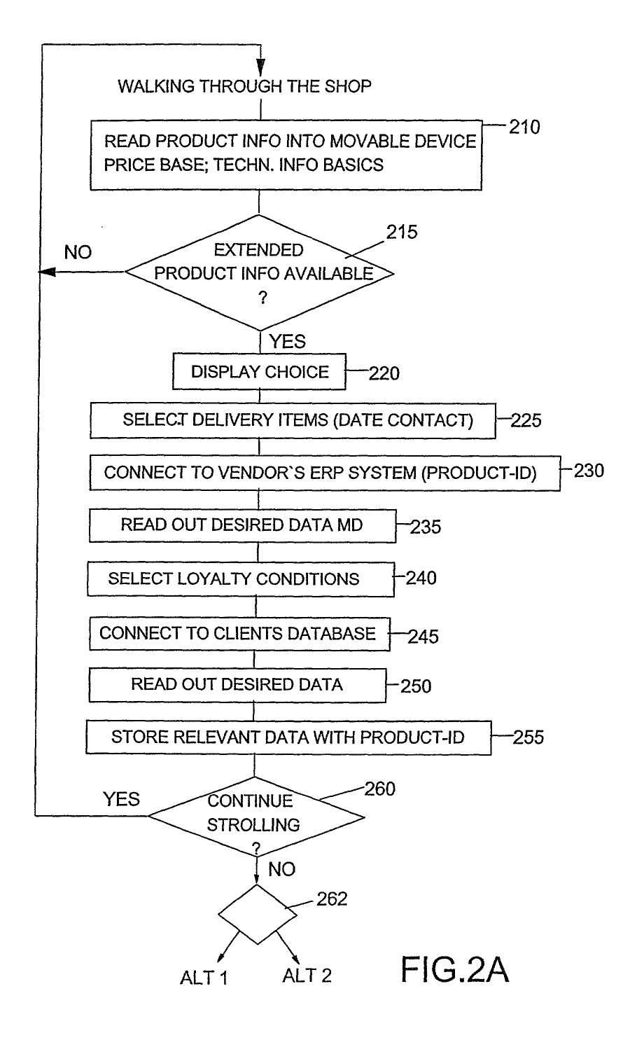

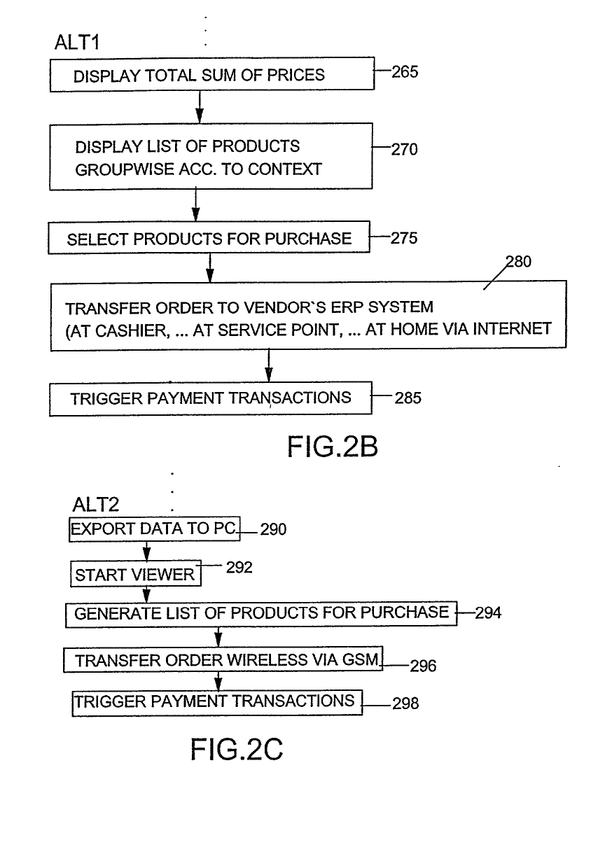

With reference to FIGS. 2A, 2B, and 3 schematic functional representations of a sample embodiment of the method of the present invention, i.e., an exemplarily chosen instantiation thereof is given next revealing some control of its control flow aspects.

In a large furniture shop, the consumer is walking through the shop. When he is interested in a particular product or product group exhibited, he downloads the respective product information from the product contact point placed next to the products into his PDST, in a read process, step 210.

Assuming the physical interface of the product contact points is an infrared port, he can extend the information service, decision 215, if desired. A respective choice of offered services is displayed on the display of the PDST, step 220. First, the user selects the delivery information service by simply selecting a respective item on the display, step 225.

The action comprising the product ID triggers a connection to the vendor's ERP system, as was mentioned further above, step 230. Then, the desired data is read out to the PDST mobile device (MD), step 235, and the customer is now allowed to determine the availability of the product, i.e., when and by which service provider the product can be delivered to him.

Further, the customer selects the personal loyalty conditions, step 240. Thus, a connection, step 245, is provided to the shop's customer database in which preferred customers are stored with the particular loyalty conditions. Thus, the customer accesses online his personal customer e-vault storing his individual payment conditions and the loyalty programs he is participating in, by reading out the respective dataset(s), step 250. Optionally, when the customer decides, the respective data items gathered in steps 210, 235, and 250 are stored with the product ID in a storage of the mobile device.

Then, the customer goes on strolling for different further products, YES branch of decision 260, and the same or a similar procedure can be performed repeatedly.

In the NO branch of decision 260 a further decision 262, see FIG. 3, is offered to the customer. The customer is offered a chance to extend his shopping tour supported with PC facilities in order to let the data be analyzed or evaluated on his desktop PC at home with further data concerning similar products offered by different vendors. The extension can be basically performed via an Internet search, or via a real-life further walk through a respective shop of a different vendor.

The extension is described with reference to FIG. 2C.

First, however, the case is described in which the customer wants to perform a purchase of at least some of the selected products immediately in the shop in which he walked through, see FIG. 2A, without a further compare with products from different vendors. Thus, the NO branch of FIG. 3 and alternative 1 in FIG. 2A will be selected by the customer. Before any purchase decision, the customer displays the total sum of prices associated with the selected products, step 265. Then he displays the list of products, step 270. Advantageously, the product list is grouped by the semantic context of the products. I.e. if for a selected product there are one or more supplementary products, they will be displayed immediately after the product in the list.

Then, the customer is enabled to definitely select the products for purchase, step 275. Of course, he is offered the possibility not to buy one or more products. Advantageously, the customer is provided with an option to store the product data even in the case when he decides not to buy them, because at some later point in time he may need the gathered data for a later purchase decision or for later processing on his desktop PC, see description of FIG. 2C.

Thus, finally the customer has selected a well-defined list of products for purchase. Then, an order representing the selected products is transferred to the vendor's ERP system, step 280. This can be done either at the cashier, at any of the above-mentioned service points, or even via the Internet at home.

Then, the respective payment transactions are triggered and can be performed according to prior art methods, step 285.

In the YES branch of FIG. 3, step 262, the shopping tour is extended as was mentioned further above. This is illustrated with reference to FIG. 2C: in the alternative which is depicted as alternative 2 in FIG. 2A the customer leaves the shop without having performed any purchase. In this case he just has filled up the PDST with a lot of product information, i.e. product data which he exports now onto his PC at home, step 290. In order to do that he advantageously is allowed to use a program which implements the above-mentioned standardized logical interface. Thus, the use of the program is easy and allows the export of data which was gathered by the PDST and, if desired, which is gathered from the Internet, as well.

According to a further, preferred aspect of the present invention, in a step 292 the product data gathered before can be viewed for further analysis, after a respective viewing tool has been started, step 292. The viewing tool uses the same standardized interface and can thus display all product data stored in a PDST, or downloaded via the Internet during a virtual shopping tour, as well. In a further extension of the tool prices can be automatically compared by the tool as well as delivery dates and further product information, including technical information.

Then, in a step 294, the customer can generate a list of products which he wants to buy. In this respect, the same options can be provided as described with reference to FIG. 2B.

Then, a respective order can be transferred via the Internet to the concerned company, step 296. Alternatively, the selected products can be imported to the PDST in order to be able to read the data again, when no purchase was performed in spite of a subsequent shopping tour, perhaps in a shop of a further different vendor. Then, it is advantageous to have the product data present in order to be able to compare it with the product data of the new competitor.

It should be noted that the step of transferring the order data, step 296, and the step of triggering the payment transactions, step 298, can be done via a wireless interface, too, for example via GSM.

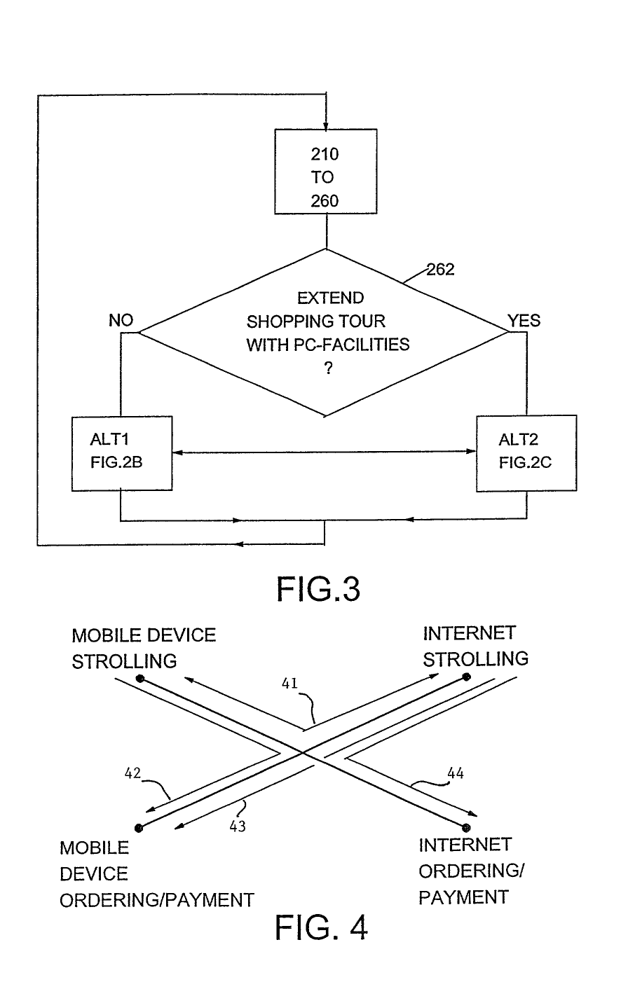

FIG. 4 illustrates the large flexibility and variability of the present invention. FIG. 4 is basically a representation of a plurality of different possibilities in which products can be explored by the customer via strolling through one or more shops, see upper left corner of the X or via Internet strolling, see upper right corner, followed by an ordering and payment process which are both able to be effected by the mobile device, see bottom left corner or by the Internet, see bottom right corner. As is revealed by the drawing the customer can use the PDST and the method of the invention for repeatedly gathering data during a real-life strolling or a virtual strolling process, see arrow 41 with a respective store process of the gathered data.

Arrow 42 shows the way of processing with immediate purchase in the shop as was described in context with FIG. 2A.

Arrow 43 shows a sequence which comprises an Internet strolling process followed by an ordering/payment process triggered by the mobile device. The arrow 44 finally represents a case as arrow 43 describes but in which the Internet is used for ordering and payment. As revealed from the above description, any product data which once has been stored on the mobile device can be evaluated with the help of a PC into which the product data can be exported via one of the above mentioned interfaces, e.g. the infrared interface. It should be added that any of the above described processes may be aborted at the customers free will, whenever he wants to do that, except when the order has not yet been transferred to the vendor's ERP system, steps 280, 296.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be realized in hardware, software, or a combination of hardware and software. A shopping tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a small portable computing device with a computer program that, when loaded and executed, controls the device such that it carries out the methods described herein. The same applies to the corresponding communication partner device, as e.g., the service point or contact point terminal with or without a respective backend connection.

The present invention can also be embedded in a computer program product, which comprises all the features enabling the implementation of the methods described herein, and which, when loaded in a computer system, is able to carry out these methods.

Computer program means or a computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A customer-associated shopping communication method in which product information is provided to a customer of a shop via an electronic shopping system, comprising the steps of:
importing product information into a customer-associated mobile computing device; and
storing the product information or a reference to it for retrieving it after import.

2. The method according to claim 1 further comprising the step of importing sales-related additional information for a product.

3. The method according to claim 1 further comprising the step of importing delivery-related information for a product.

4. The method according to claim 1 further comprising the step of creating an order for a product.

5. The method according to claim 4 further comprising the step of sending the order for the product to the associated vendor.

6. The method according to claim 1 further comprising the step of initiating a payment for a product.

7. The method according to claim 1 further comprising the step of evaluating the product information with respective information associated to products from other vendors.

8. The method according to claim I in which a standardized interface is used for implementing the multiplicity of steps.

9. The method according to claim 8 in which XML is used for programming.

10. The method according to claim 1 in which a hardware interface is used between the customer computing device and the vendor which is adapted to the functionality of the interface.

11. A computer program comprising code portions adapted for performing the steps according to the method according to claim 1 when the program is loaded into a computer device.

12. A computer program product stored on a computer usable medium comprising computer readable program means for causing a computer to perform the method of claim 1.

13. A mobile computing device comprising:
means for importing multiple, vendor-specific product information; and
means for storing the product information or a reference to it for retrieving it after import.

14. The device according to claim 13 further comprising means for importing sales-related additional information for a product.

15. The device according to claim 13 further comprising means for importing delivery-related information for a product.

16. The device according to claim 13 further comprising means for creating an order for a product.

17. The device according to claim 16 further comprising means for sending the order for the product to the associated vendor.

18. The device according to claim 13 further comprising means for initiating a payment for a product.

19. A shop-associated shopping communication method in which product information is provided to a computing device associated to a customer, comprising the step of:
providing an export of multiple, vendor-specific product information into the customer-associated computing device.

20. The method according to claim 19 further comprising the step of exporting sales-related additional information for the product.

21. The method according to claim 19 further comprising the step of exporting delivery-related information for the product.

22. The method according to claim 19 further comprising the step of receiving and processing an order for the product.

23. The method according to claim 19 further comprising the step of receiving a payment for the product.

24. The method according to claim 19 in which XML is used for programming.

25. A computer program comprising code portions adapted for performing the steps according to the method according to claim 19 when the program is loaded into a computer device.

26. A computer program product stored on a computer usable medium comprising computer readable program means for causing a computer to perform the method of claim 19.

27. A computing device having means for performing the method of claim 19.

28. The device according to claim 27 which is connectable to a goods database of a warehouse.
